(19) United States
(12) Patent Application Publication
(10) Pub. No.: US 2025/0293386 A1
(43) Pub. Date: Sep. 18, 2025

(54) POWER STORAGE DEVICE AND VEHICLE

(71) Applicant: TOYOTA JIDOSHA KABUSHIKI KAISHA, Aichi-ken (JP)

(72) Inventors: Akio UOTANI, Nagoya-shi (JP); Dexu ZHANG, Mishima-shi (JP); Yoshinobu KUROYAMA, Aichi-gun (JP); Daisuke KAMESAKI, Okazaki-shi (JP); Seigo FUJISHIMA, Miyoshi-shi (JP); Yuki TAKAHASHI, Miyoshi-shi (JP)

(21) Appl. No.: 19/039,787

(22) Filed: Jan. 29, 2025

(30) Foreign Application Priority Data
Mar. 15, 2024 (JP) 2024-041169

(51) Int. Cl. H01M 50/367; H01M 50/209; H01M 50/249

(52) U.S. Cl. CPC H01M 50/367; H01M 50/249; H01M 50/209; H01M 2200/20

(57) ABSTRACT

A power storage device includes: a first power storage stack and a second power storage stack spaced apart from each other in a first direction; and an accommodation case, wherein the accommodation case is provided with a case-side exhaust valve, the first power storage stack includes a plurality of first unit cells arranged in a second direction orthogonal to the first direction, the second power storage stack includes a plurality of second unit cells arranged in the second direction, each of the plurality of first unit cells is provided with a first exhaust valve that can discharge a gas toward a side opposite to a side where the second power storage stack is located, and each of the plurality of second unit cells is provided with a second exhaust valve that can discharge a gas toward a side opposite to a side where the first power storage stack is located.

### CROSS REFERENCE TO RELATED APPLICATIONS

This nonprovisional application is based on Japanese Patent Application No. 2024-041169 filed on Mar. 15, 2024 with the Japan Patent Office, the entire contents of which are hereby incorporated by reference.

### BACKGROUND

### Field

The present disclosure relates to a power storage device and a vehicle including the power storage device.

### Description of the Background Art

As a conventional power storage device, Japanese Patent Laying-Open No. 2019-192415 discloses a configuration in which power storage stacks are disposed to be adjacent to each other, each of the power storage stacks including stacked power storage cells, each of the power storage cells including an exhaust valve in a side surface thereof. In each of the power storage stacks, each exhaust valve faces the side surface side of an accommodation case.

### SUMMARY

In recent years, a length of a power storage cell (unit cell) in a longitudinal direction has been becoming longer in response to an increase in capacity. In order to enhance the efficiency of discharging gas from a power storage cell, it is conceivable to provide exhaust valves on both side surfaces in the longitudinal direction. However, in the case where a plurality of power storage stacks each including power storage cells arranged in a direction orthogonal to the longitudinal direction are disposed side by side in the above-described longitudinal direction, when one power storage stack of the power storage stacks adjacent to each other generates heat, a gas is discharged from one power storage stack to the other power storage stack. Similarly, when the other power storage stack generates heat, a gas is discharged from the other power storage stack to one power storage stack. In such a case, there is a concern that even when any one of the power storage stacks adjacent to each other generates heat, the power storage stacks adjacent to each other may mutually generate heat.

The present disclosure has been made in view of the above-described problem and an object of the present disclosure is to provide a power storage device in which mutual heat generation of power storage stacks adjacent to each other can be suppressed, and a vehicle.

A power storage device according to the present disclosure includes: a first power storage stack and a second power storage stack; and an accommodation case that accommodates the first power storage stack and the second power storage stack. The accommodation case is provided with a case-side exhaust valve that can discharge a gas discharged into the accommodation case. The first power storage stack and the second power storage stack are spaced apart from each other and disposed side by side in a first direction. The first power storage stack includes a plurality of first unit cells arranged in a second direction orthogonal to the first direction. The second power storage stack includes a plurality of second unit cells arranged in the second direction. Each of the plurality of first unit cells is provided with a first exhaust valve that can discharge a gas toward a side opposite to a side where the second power storage stack is located. Each of the plurality of second unit cells is provided with a second exhaust valve that can discharge a gas toward a side opposite to a side where the first power storage stack is located.

According to the above-described configuration, the gas from the first power storage stack is discharged toward the side opposite to the side where the second power storage stack is located, and the gas from the second power storage stack is discharged toward the side opposite to the side where the first power storage stack is located. Thus, when the gas is discharged from one power storage stack of the first power storage stack and the second power storage stack, a flow of the discharged gas to the other power storage stack can be suppressed. As a result, even when one power storage stack generates heat, mutual heat generation of the first power storage stack and the second power storage stack can be suppressed.

The power storage device according to the present disclosure may further include an electric device accommodated in the accommodation case to control the first power storage stack and the second power storage stack. The accommodation case may include a first wall portion located on one side in the first direction, and a second wall portion located on the other side in the first direction. The electric device may include a first electric device disposed in a gap between the first wall portion and the first power storage stack, and a second electric device disposed in a gap between the second wall portion and the second power storage stack.

According to the above-described configuration, the first electric device is disposed between the first power storage stack and the first wall portion, and there is a relatively large area therebetween. Similarly, the second electric device is disposed between the second power storage stack and the second wall portion, and there is a relatively large area therebetween. By using such areas as exhaust paths, the space in the accommodation case can be effectively used.

In addition, since the areas in the accommodation case can be used as the exhaust paths, a decrease in rigidity of the accommodation case can be suppressed, as compared with a configuration in which a plurality of through holes communicating with a plurality of first exhaust valves and a plurality of second exhaust valves, respectively, are provided in a wall portion of an accommodation case facing the plurality of first exhaust valves and a wall portion of the accommodation case facing the plurality of second exhaust valves.

In the power storage device according to the present disclosure, the case-side exhaust valve may be provided in each of the first wall portion and the second wall portion.

According to the above-described configuration, the gases discharged from the first power storage stack and the second power storage stack into the accommodation case can be efficiently discharged to the outside of the accommodation case.

The power storage device according to the present disclosure may further include an electric device accommodated in the accommodation case to control the first power storage stack and the second power storage stack. The accommodation case may include a first wall portion located on one side in the first direction, a second wall portion located on the other side in the first direction, and a pair of side wall portions that connect the first wall portion and the second wall portion. The electric device may be disposed between the first wall portion and the first power storage stack. The case-side exhaust valve may be provided in the first wall portion. An exhaust path extending to the case-side exhaust valve may be provided inside the first wall portion, the second wall portion, and at least one of the pair of side wall portions.

According to the above-described configuration, the gas discharged from the first power storage stack can be discharged from the first wall portion side, and the gas discharged from the second power storage stack can flow through the inner side of the wall portions of the accommodation case and be discharged from the first wall portion side.

In the power storage device according to the present disclosure, a first connector electrically connected to the first power storage stack and a second connector electrically connected to the second power storage stack may be provided on one side of the first wall portion in the second direction. The case-side exhaust valve provided in the first wall portion may be provided on the other side of the first wall portion in the second direction.

According to the above-described configuration, the gas flows to a side opposite to a side where the first connector and the second connector are located, and thus, breakage of the first connector and the second connector due to heat can be suppressed.

A vehicle according to the present disclosure includes: the above-described power storage device; and a vehicle body having the power storage device fixed thereto.

According to the above-described configuration, since the vehicle includes the above-described power storage device, mutual heat generation of the first power storage stack and the second power storage stack in the vehicle can be suppressed.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic view showing a vehicle having a power storage device according to a first embodiment mounted thereon.

FIG. 2 shows a state in which the power storage device according to the first embodiment is fixed to the vehicle.

FIG. 3 is a schematic exploded perspective view of the power storage device according to the first embodiment.

FIG. 4 is a schematic plan view showing how a gas moves when a specified unit cell generates heat in the power storage device according to the first embodiment.

FIG. 5 is a schematic plan view showing how a gas moves when a specified unit cell generates heat in a power storage device according to a second embodiment.

### DESCRIPTION OF THE PREFERRED EMBODIMENTS

Hereinafter, embodiments of the present disclosure will be described in detail with reference to the drawings. In the embodiments described below, the same or common portions are denoted by the same reference characters in the drawings, and description thereof will not be repeated.

### First Embodiment

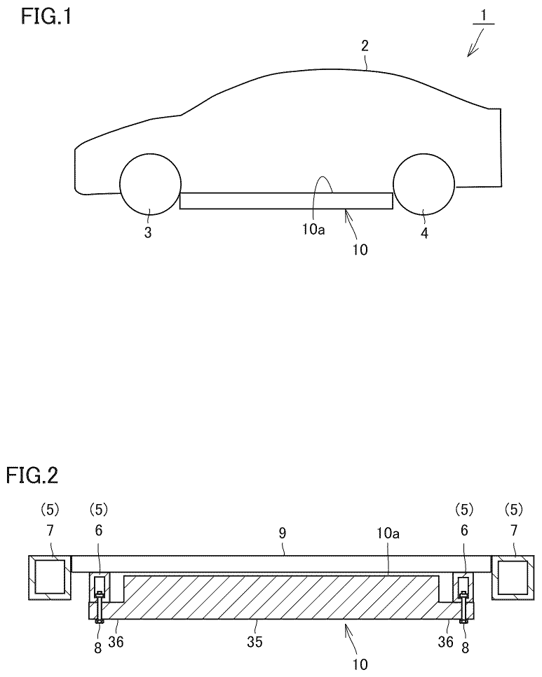

FIG. 1 is a schematic view showing a vehicle having a power storage device according to a first embodiment mounted thereon. FIG. 2 shows a state in which the power storage device according to the first embodiment is fixed to the vehicle. A vehicle 1 according to the first embodiment will be described with reference to FIGS. 1 and 2.

Vehicle 1 is a hybrid vehicle that can travel using motive power of at least one of a motor and an engine, or an electrically powered vehicle that travels using driving force obtained by electrical energy.

Vehicle 1 includes a vehicle main body 2, a front wheel 3, a rear wheel 4, and a power storage device 10. Vehicle main body 2 includes a frame member 5. Power storage device 10 is disposed below vehicle main body 2. Power storage device 10 is disposed between front wheel 3 and rear wheel 4, for example. A part of power storage device 10 may be disposed to overlap with at least one of front wheel 3 and rear wheel 4 when viewed in a width direction of vehicle 1. Power storage device 10 has an upper surface 10a. Upper surface 10a may function as a floor member that defines a vehicle interior.

Frame member 5 includes a pair of side members 6 and a pair of side sills 7. The pair of side sills 7 are disposed at both ends in the width direction of vehicle 1. The pair of side members 6 are disposed inside the pair of side sills 7 with a distance therebetween. The pair of side members 6 and the pair of side sills 7 extend along a front-rear direction of vehicle 1.

The pair of side members 6 are spaced apart from each other in the width direction of vehicle 1. A main body portion 35 of power storage device 10 is disposed in a gap between the pair of side members 6. A void space is provided between main body portion 35 and the pair of side members 6. As a result, even when vehicle 1 experiences side collision, input of the impact to power storage device 10 can be suppressed.

Fixed portions 36 are provided on both side surfaces of main body portion 35 in the width direction of vehicle 1. Fixed portions 36 are fixed to the pair of side members 6 by fastening members 8, respectively.

Frame member 5 also includes a cross frame member 9. Cross frame member 9 is provided above power storage device 10 to extend from one side sill 7 to the other side sill 7. Upper surface 10a of power storage device 10 is fixed to cross frame member 9.

Although the example in which frame member 5 includes the pair of side members 6 and the pair of side sills 7 has been illustrated and described above, the present disclosure is not limited thereto. The pair of side sills 7 may have the function of the pair of side members 6. In this case, the pair of side members 6 can be omitted and fixed portions 36 described above may be fixed to the pair of side sills 7.

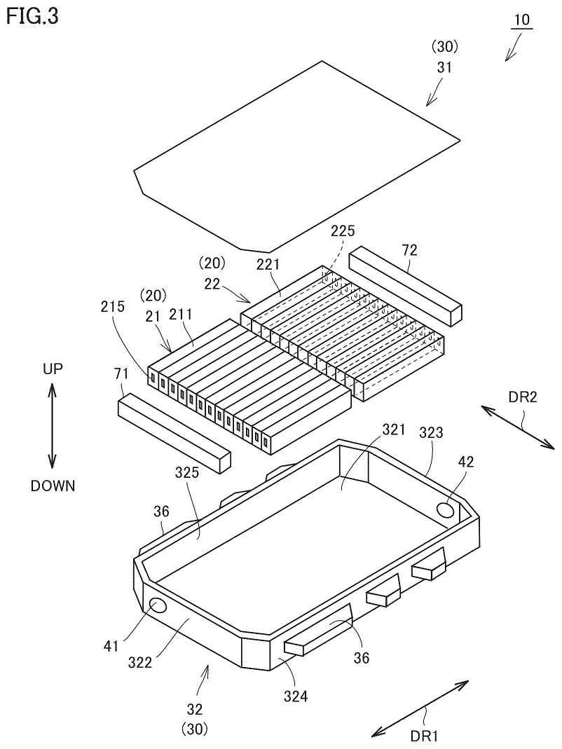

FIG. 3 is a schematic exploded perspective view of the power storage device according to the first embodiment. A detailed configuration of power storage device 10 will be described with reference to FIG. 3.

Power storage device 10 includes a plurality of power storage modules 20, an accommodation case 30, case-side exhaust valves 41 and 42, and a first electric device 71 and a second electric device 72.

The plurality of power storage modules 20 are disposed side by side in a first direction (DR1 direction). The first direction is, for example, parallel to the front-rear direction of vehicle 1 in a mounted state in which power storage device 10 is mounted on vehicle 1. The plurality of power storage modules 20 include a first power storage stack 21 and a second power storage stack 22. First power storage stack 21 and second power storage stack 22 are spaced apart from each other and disposed side by side in the first direction.

First power storage stack 21 includes a plurality of first unit cells 211. The plurality of first unit cells 211 are arranged in a second direction (DR2 direction) orthogonal to the first direction. The second direction is, for example, parallel to a left-right direction of vehicle 1 in the above-described mounted state.

Each of first unit cells 211 is provided with a first exhaust valve 215. First exhaust valve 215 is provided to be capable of discharging a gas toward a side opposite to a side where second power storage stack 22 is located. First exhaust valve 215 is provided in a side surface of first unit cell 211 located on one side in the first direction. First exhaust valve 215 is a valve for discharging an emission from the inside of first unit cell 211 when a pressure in first unit cell 211 becomes higher than a predetermined pressure.

Second power storage stack 22 includes a plurality of second unit cells 221. The plurality of second unit cells 221 are arranged in the second direction. Each of second unit cells 221 is provided with a second exhaust valve 225. Second exhaust valve 225 is provided to be capable of discharging a gas toward a side opposite to a side where first power storage stack 21 is located. Second exhaust valve 225 is provided in a side surface of second unit cell 221 located on the other side in the first direction. Second exhaust valve 225 is a valve for discharging an emission from the inside of second unit cell 221 when a pressure in second unit cell 221 becomes higher than a predetermined pressure.

Each of first unit cells 211 and second unit cells 221 has an elongated shape whose longitudinal direction is the first direction. Each of first unit cells 211 and second unit cells 221 has a flat rectangular parallelepiped shape having a thickness in the second direction.

First unit cells 211 and second unit cells 221 may be configured by the same power storage cell. In this case, the number of components can be reduced, and the manufacturing cost can be reduced. It should be noted that “same” encompasses the inclusion of manufacturing errors such as tolerance. Alternatively, first unit cells 211 and second unit cells 221 may be configured by different power storage cells.

Each of first unit cells 211 and second unit cells 221 includes a housing, and a single or a plurality of electrode assemblies are accommodated in the housing.

When a single electrode assembly is accommodated in the housing, the electrode assembly has a shape extending in the above-described longitudinal direction. The electrode assembly may be a stacked electrode assembly in which a negative electrode sheet, a separator and a positive electrode sheet are stacked, or may be a wound electrode assembly in which a negative electrode sheet, a separator and a positive electrode sheet are wound.

When a plurality of electrode assemblies are accommodated in the housing, the plurality of electrode assemblies are disposed side by side in the longitudinal direction and are connected in series. In this case as well, each of the electrode assemblies may be a stacked electrode assembly, or may be a wound electrode assembly.

Each of first unit cells 211 and second unit cells 221 is a secondary battery such as a nickel-metal hydride battery or a lithium ion battery. Each of first unit cells 211 and second unit cells 221 may be a unit cell including a liquid electrolyte, or may be a unit cell including a solid electrolyte. Each of first unit cells 211 and second unit cells 221 may be a chargeable and dischargeable capacitor.

Accommodation case 30 includes an upper member 31 and a lower member 32 serving as a lower case. Lower member 32 has a substantially box shape that is opened upward. Lower member 32 includes main body portion 35 and fixed portions 36.

Main body portion 35 has a bottom wall portion 321, a first wall portion 322, a second wall portion 323, and a pair of side wall portions 324 and 325. First wall portion 322, second wall portion 323, and the pair of side wall portions 324 and 325 are provided to rise from a perimeter edge of bottom wall portion 321.

First wall portion 322 and second wall portion 323 face each other in the first direction. First wall portion 322 is located on one side in the first direction. Second wall portion 323 is located on the other side in the first direction. The pair of side wall portions 324 and 325 face each other in the second direction. The pair of side wall portions 324 and 325 connect first wall portion 322 and second wall portion 323 to each other. Side wall portion 324 connects end portions of first wall portion 322 and second wall portion 323 located on one side in the second direction. Side wall portion 325 connects end portions of first wall portion 322 and second wall portion 323 located on the other side in the second direction.

Fixed portions 36 are provided on outer surfaces of the pair of side wall portions 324 and 325. Each of fixed portions 36 is provided to intermittently extend in the first direction. A portion of fixed portion 36 located closest to one side in the first direction is longer in length in the first direction than the other portion. Case-side exhaust valves 41 and 42 function as pressure relief valves and discharge the gas in accommodation case 30 to the outside of accommodation case 30 when a pressure in accommodation case 30 becomes higher than a predetermined pressure. Case-side exhaust valve 41 is provided in first wall portion 322. Case-side exhaust valve 42 is provided in second wall portion 323. Case-side exhaust valves 41 and 42 are, for example, provided diagonally when viewed in a plan view. More particularly, case-side exhaust valve 42 is provided on one side of second wall portion 323 in the second direction, and case-side exhaust valve 41 is provided on the other side of first wall portion 322 in the second direction.

First electric device 71 is disposed between first wall portion 322 and first power storage stack 21. Second electric device 72 is disposed between second wall portion 323 and second power storage stack 22. Each of first electric device 71 and second electric device 72 is, for example, a junction block including a battery ECU for controlling a power storage module, a relay for permitting and prohibiting charging and discharging between a battery pack and the outside, and the like.

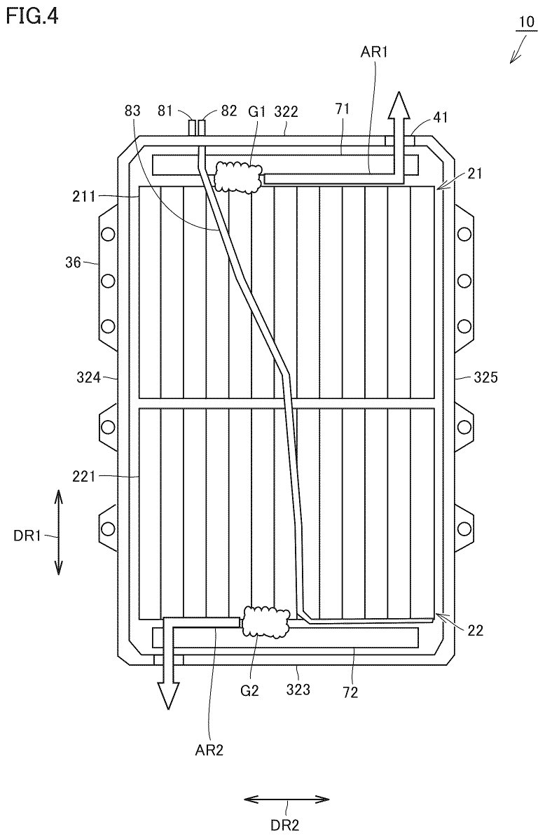

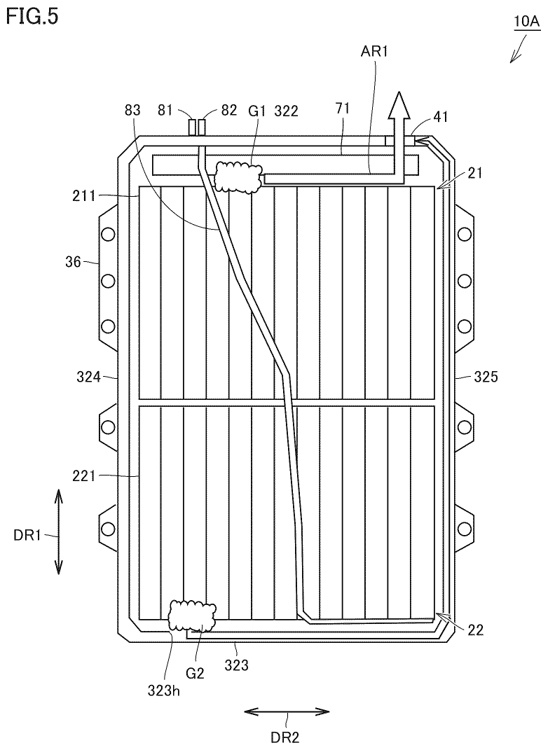

FIG. 4 is a schematic plan view showing how a gas moves when a specified unit cell generates heat in the power storage device according to the first embodiment. Movement of a gas generated from first power storage stack 21 and movement of a gas generated from second power storage stack 22 will be described with reference to FIG. 4.

As shown in FIG. 4, first wall portion 322 is provided with a first connector 81 and a second connector 82. First power storage stack 21 and second power storage stack 22 are electrically connected in series, and first connector 81 is electrically connected to a first external terminal (positive electrode terminal) of first power storage stack 21. Second connector 82 is connected to a second external terminal (negative electrode terminal) of second power storage stack 22 via a wire 83.

First connector 81 and second connector 82 are disposed on one side of first wall portion 322 in the second direction, and case-side exhaust valve 41 is disposed on the other side of first wall portion 322 in the second direction. The position of case-side exhaust valve 41 is not limited to the above-described position and can be set as appropriate as long as case-side exhaust valve 41 is disposed in first wall portion 322. Case-side exhaust valve 42 is disposed on one side in the second direction in second wall portion 323. Case-side exhaust valve 42 is provided on a side opposite to a side where a connection portion that connects wire 83 and second power storage stack 22 is located, in the second direction. The position of case-side exhaust valve 42 is not limited to the above-described position and can be set as appropriate as long as case-side exhaust valve 42 is disposed in second wall portion 323.

When a gas G1 is discharged from specified first unit cell 211 of first power storage stack 21, gas G1 is discharged toward the side opposite to the side where second power storage stack 22 is located, because case-side exhaust valve 41 is provided on the side opposite to the side where second power storage stack 22 is located as described above.

Similarly, when a gas G2 is discharged from specified second unit cell 221 of second power storage stack 22, gas G2 is discharged toward the side opposite to the side where first power storage stack 21 is located, because case-side exhaust valve 42 is provided on the side opposite to the side where first power storage stack 21 is located as described above.

Thus, when the gas is discharged from one power storage stack of first power storage stack 21 and second power storage stack 22, a flow of the discharged gas to the other power storage stack can be suppressed. As a result, even when one power storage stack generates heat, mutual heat generation of first power storage stack 21 and second power storage stack 22 can be suppressed.

Gas G1 from first power storage stack 21 is discharged toward the first electric device 71 side. A relatively large area where first electric device 71 is disposed is provided between first power storage stack 21 and first wall portion 322. Gas G1 is discharged toward this area and is discharged to the outside of accommodation case 30 through case-side exhaust valve 41 provided in first wall portion 322.

Similarly, gas G2 from second power storage stack 22 is discharged toward the second electric device 72 side. A relatively large area where second electric device 72 is disposed is provided between second power storage stack 22 and second wall portion 323. Gas G2 is discharged toward this area and is discharged to the outside of accommodation case 30 through case-side exhaust valve 42 provided in second wall portion 323.

Since the relatively large areas in accommodation case 30 are used as exhaust paths as described above, the space in accommodation case 30 can be effectively used and a flow of the gas from one power storage stack to the other power storage stack can be suppressed.

In addition, since case-side exhaust valve 41 is provided in first wall portion 322 and case-side exhaust valve 42 is provided in second wall portion 323, the gas discharged from first power storage stack 21 or second power storage stack 22 into accommodation case 30 can be efficiently discharged to the outside of accommodation case 30.

Furthermore, since the areas in accommodation case 30 can be used as exhaust paths, a decrease in rigidity of accommodation case 30 can be suppressed, as compared with a configuration in which a plurality of through holes communicating with a plurality of first exhaust valves 215 and a plurality of second exhaust valves 225, respectively, are provided in first wall portion 322 facing the plurality of first exhaust valves 215 and second wall portion 323 of the accommodation case facing the plurality of second exhaust valves 225.

In addition, case-side exhaust valve 41 is provided on the side opposite to the side where first connector 81 and second connector 82 are located, in the second direction. Therefore, gas G1 flows to the side opposite to the side where first connector 81 and second connector 82 are located, and thus, breakage of first connector 81 and second connector 82 due to heat can be suppressed.

Similarly, case-side exhaust valve 42 is provided on the side opposite to the side where the above-described connection portion that connects wire 83 and second power storage stack 22 is located, in the second direction. Therefore, gas G2 flows to the side opposite to the side where the connection portion is located, and thus, breakage of the connection portion due to heat can be suppressed.

### Second Embodiment

FIG. 5 is a schematic plan view showing how a gas moves when a specified unit cell generates heat in a power storage device according to a second embodiment. A power storage device 10A according to the second embodiment will be described with reference to FIG. 5.

As shown in FIG. 5, power storage device 10A according to the second embodiment is different from power storage device 10 according to the first embodiment in that second electric device 72 is not provided, in that case-side exhaust valve 42 is not provided in second wall portion 323, and in terms of the exhaust path of gas G2 from the second power storage stack 22 side.

As to the electric device, in power storage device 10A, first electric device 71 is disposed between first wall portion 322 and first power storage stack 21, and no electric device is disposed between second wall portion 323 and second power storage stack 22.

In addition, an introduction port 323h through which gas G2 is introduced is provided in an inner surface of second wall portion 323. Introduction port 323h is provided on the side opposite to the side where the connection portion that connects wire 83 and second power storage stack 22 is located, in the second direction. An exhaust path extending from introduction port 323h to case-side exhaust valve 41 is provided inside second wall portion 323 of accommodation case 30, inside first wall portion 322, and inside at least one of the pair of side wall portions 324 and 325.

When gas G1 is discharged from specified first unit cell 211 of first power storage stack 21, gas G1 is discharged toward an area where first electric device 71 is disposed, and this area functions as a part of the exhaust path and gas G1 is discharged through case-side exhaust valve 41, similarly to the first embodiment.

On the other hand, when gas G2 is discharged from specified second unit cell 221 of second power storage stack 22, gas G2 discharged toward the side opposite to the side where first power storage stack 21 is located is introduced into second wall portion 323 through introduction port 323h, flows through the above-described exhaust path provided inside the wall portions of accommodation case 30, and is discharged to the outside of accommodation case 30 through case-side exhaust valve 41.

With the above-described configuration as well, power storage device 10A according to the second embodiment can obtain substantially the same effect as that of power storage device 10 according to the first embodiment. Particularly, even when there is no area where second electric device 72 is disposed on the second wall portion 323 side, the above-described configuration allows gas G2 discharged from second power storage stack 22 to flow through the inner side of the wall portions of accommodation case 30 and be discharged from the first wall portion 322 side. Thus, a flow of gas G2 discharged from second power storage stack 22 directly to first power storage stack 21 can be suppressed, and an increase in temperature of first power storage stack 21 due to gas G2 can be suppressed.

Although the embodiments of the present disclosure have been described, it should be understood that the embodiments disclosed herein are illustrative and non-restrictive in every respect. The scope of the present disclosure is defined by the terms of the claims, and is intended to include any modifications within the scope and meaning equivalent to the terms of the claims.

What is claimed is:

1. A power storage device comprising:
a first power storage stack and a second power storage stack; and
an accommodation case that accommodates the first power storage stack and the second power storage stack, wherein
the accommodation case is provided with a case-side exhaust valve that can discharge a gas discharged into the accommodation case,
the first power storage stack and the second power storage stack are spaced apart from each other and disposed side by side in a first direction,
the first power storage stack includes a plurality of first unit cells arranged in a second direction orthogonal to the first direction,
the second power storage stack includes a plurality of second unit cells arranged in the second direction,
each of the plurality of first unit cells is provided with a first exhaust valve that can discharge a gas toward a side opposite to a side where the second power storage stack is located, and
each of the plurality of second unit cells is provided with a second exhaust valve that can discharge a gas toward a side opposite to a side where the first power storage stack is located.

2. The power storage device according to claim 1, further comprising
an electric device accommodated in the accommodation case to control the first power storage stack and the second power storage stack, wherein
the accommodation case includes a first wall portion located on one side in the first direction, and a second wall portion located on the other side in the first direction, and
the electric device includes a first electric device disposed in a gap between the first wall portion and the first power storage stack, and a second electric device disposed in a gap between the second wall portion and the second power storage stack.

3. The power storage device according to claim 2, wherein
the case-side exhaust valve is provided in each of the first wall portion and the second wall portion.

4. The power storage device according to claim 1, further comprising
an electric device accommodated in the accommodation case to control the first power storage stack and the second power storage stack, wherein
the accommodation case includes a first wall portion located on one side in the first direction, a second wall portion located on the other side in the first direction, and a pair of side wall portions that connect the first wall portion and the second wall portion,
the electric device is disposed between the first wall portion and the first power storage stack,
the case-side exhaust valve is provided in the first wall portion, and
an exhaust path extending to the case-side exhaust valve is provided inside the first wall portion, the second wall portion, and at least one of the pair of side wall portions.

5. The power storage device according to claim 2, wherein
a first connector electrically connected to the first power storage stack and a second connector electrically connected to the second power storage stack are provided on one side of the first wall portion in the second direction, and
the case-side exhaust valve provided in the first wall portion is provided on the other side of the first wall portion in the second direction.

6. A vehicle comprising:
the power storage device as recited in claim 1; and
a vehicle body having the power storage device fixed thereto.
